(19) United States
(12) Patent Application Publication
(10) Pub. No.: US 2024/0204502 A1
(43) Pub. Date: Jun. 20, 2024

(54) SHORT-CIRCUIT PROTECTION SYSTEM, SHORT-CIRCUIT PROTECTION APPARATUS, SHORT-CIRCUIT PROTECTION METHOD AND PROGRAM

(71) Applicant: NIPPON TELEGRAPH AND TELEPHONE CORPORATION, Tokyo (JP)

(72) Inventors: Yuji HIGUCHI, Tokyo (JP); Naoki HANAOKA, Tokyo (JP); Naomichi NAKAMURA, Tokyo (JP); Toru TANAKA, Tokyo (JP)

(21) Appl. No.: 18/557,386

(22) PCT Filed: Apr. 30, 2021
(86) PCT No.: PCT/JP2021/017245

§ 371 Date: Oct. 26, 2023

(51) Int. Cl. H02H 3/06; H02H 1/00; H02H 3/08

(52) U.S. Cl. CPC H02H 3/063; H02H 1/0061; H02H 3/08

(57) ABSTRACT

A short-circuit protection system includes a plurality of short-circuit protection devices. Each of the plurality of short-circuit protection devices includes a memory and a processor configured to acquire data indicating a current value of an electric wire; transmit a first signal to one or more other short-circuit protection devices, in response to the current value exceeding a threshold; receive a second signal from each of the one or more other short-circuit protection devices; and control a circuit breaker to cut off a current of the electric wire, or controls the circuit breaker to re-close, based on whether or not the second signal from said each of the one or more other short-circuit protection devices is received.

### TECHNICAL FIELD

The present invention relates to a short-circuit protection system, a short-circuit protection device, a short-circuit protection method, and a program.

### BACKGROUND ART

In order to improve the supply reliability of a power supply system and to speed up the recovery from an accident, there is known a technique for controlling a circuit breaker that separates electric wire lines.

NPL 1 discloses a circuit breaker that collects information on the measured values of each circuit breaker via a network, and controls interruption and re-closing of the circuit breaker during a short circuit accident based on the measured data collected by a central control server.

### CITATION LIST

### Non Patent Literature

[NPL 1] “Development of a remote controller for an automatic switch utilizing IED,” Tomotake Hakamada, Takaoka Tokyo Technical Report Vol. 4 2017,P17-18, [online],Internet <URL:https://www.tktk.co.jp/research/report/pdf/2017/giho2017_all.pdf>

### SUMMARY OF INVENTION

### Technical Problem

In the prior art, information is sent to a central control server, and the central control server processes data, sends signals, and so on, which causes delays due to data processing time and communication time, resulting in longer current interruption times.

When the current interruption time becomes long, the voltage of the system drops, and there is a possibility that an ICT apparatus such as a server to which power is supplied cannot continue operation.

The disclosed technique aims to shorten the power outage time by high-speed interruption or high-speed re-closing.

### Solution to Problem

The disclosed technique is a short-circuit protection system including a plurality of short-circuit protection devices, wherein each of the plurality of short-circuit protection devices includes a current value acquisition unit that acquires data indicating a current value of an electric wire, a signal transmission unit that transmits a signal to another short-circuit protection device when the current value exceeds a threshold, a signal reception unit that receives a signal from another short-circuit protection device, and an interruption control unit that controls a circuit breaker to cut off a current of the electric wire or controls the circuit breaker to re-close, based on whether or not the signal from said another short-circuit protection device is received.

### Advantageous Effects of Invention

The power outage time can be shortened by high-speed interruption or high-speed re-closing.

### BRIEF DESCRIPTION OF DRAWINGS

FIG. 1 is a diagram showing a system configuration of a short-circuit protection system.

FIG. 2 is a diagram showing a functional configuration of a short-circuit protection device.

FIG. 3 is a flowchart showing an example of a flow of interruption control processing according to a first embodiment.

FIG. 4 is a diagram for explaining interruption control according to Example 1.

FIG. 5 is a diagram for explaining interruption control according to Example 2.

FIG. 6 is a diagram for explaining interruption control according to Example 3.

FIG. 7 is a diagram for explaining interruption control according to Example 4.

FIG. 8 is a flowchart showing an example of a flow of interruption control processing according to a second embodiment.

### DESCRIPTION OF EMBODIMENTS

### First Embodiment

Hereinafter, embodiments of the present invention will be described with reference to the drawings. The embodiments to be described below are merely examples, and embodiments to which the present invention is applied are not limited to the following embodiments.

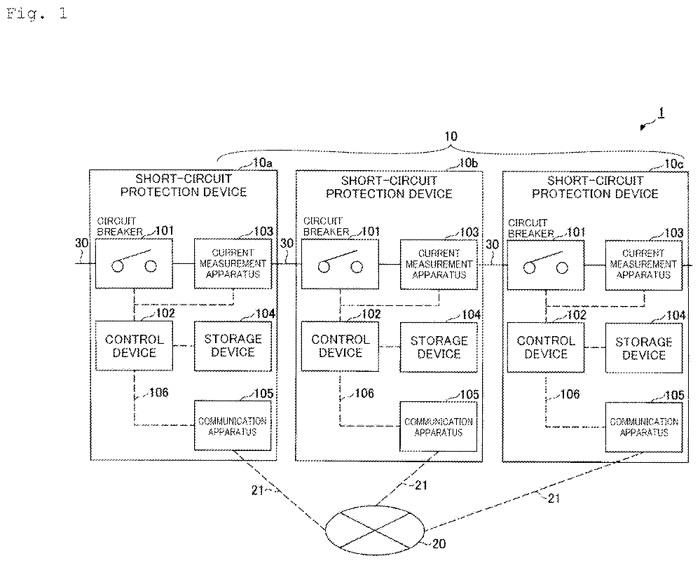

FIG. 1 is a diagram showing a system configuration of a short-circuit protection system.

A short-circuit protection system 1 according to the present embodiment is a system for protecting each device connected to an electric wire 30 from a short circuit occurring at any place of the electric wire 30. The short-circuit protection system 1 includes a plurality of short-circuit protection devices 10 (for example, short-circuit protection devices 10a, 10b and 10c).

The short-circuit protection devices 10 are connected to each other via a communication network 20 and a communication line 21 so as to be able to communicate with each other. The short-circuit protection devices 10 include a circuit breaker 101, a control device 102, a current measurement apparatus 103, a storage device 104, a communication apparatus 105, and a bus 106.

The circuit breaker 101 is an apparatus for cutting off a current of the electric wire 30. The control device 102 is a device that controls the circuit breaker 101. The control device 102 is, for example, a CPU (Central Processing Unit).

The current measurement apparatus 103 is an apparatus for measuring a current value of the electric wire 30. The current measurement apparatus 103 measures a current value periodically or in response to a request from the control device 102, and transmits data indicating the measurement result to the control device 102.

The storage device 104 stores various information such as a program or setting information used for control by the control device 102.

The communication apparatus 105 is an apparatus that communicates with another short-circuit protection device 10 via the communication line 21 and the communication network 20.

The control device 102, the storage device 104 and the communication apparatus 105 work together to function as a computer. That is, the short-circuit protection devices 10 are constituted by a computer.

The control device 102 is connected to the circuit breaker 101, the current measurement apparatus 103, the storage device 104, and the communication apparatus 105 via the bus 106 so as to be able to communicate with each other.

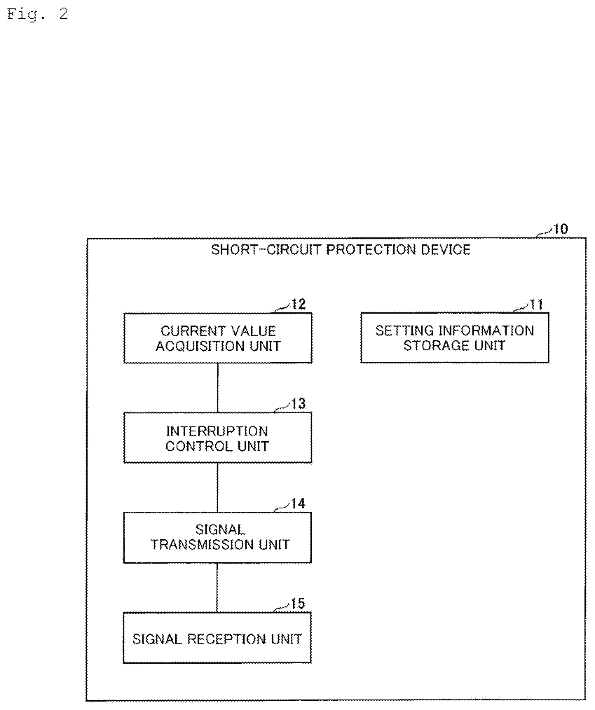

FIG. 2 is a diagram showing a functional configuration of the short-circuit protection device.

The short-circuit protection device 10 includes a setting information storage unit 11, a current value acquisition unit 12, an interruption control unit 13, a signal transmission unit 14, and a signal reception unit 15. Each of these units is implemented by the control device 102 reading a program stored in the storage device 104 or the like, executing processing regulated by the read program, and controlling the circuit breaker 101, the current measurement apparatus 103, the storage device 104, the communication apparatus 105, and the like.

The setting information storage unit 11 stores setting information. The setting information includes the number of the other short-circuit protection devices 10, communication destination addresses of the other short-circuit protection devices 10, a cut-off threshold, a signal waiting time, and the like.

The number of the other short-circuit protection devices 10 includes the number (N) of the short-circuit protection devices positioned on one side and the number (M) of the short-circuit protection devices positioned on the other side along the current of the electric wire 30. Depending on the direction of the current at the time of short-circuiting, the upstream has N short-circuit protection devices and the downstream has M short-circuit protection devices, or the upstream has M short-circuit protection devices and the downstream has N short-circuit protection devices. The number of the other short-circuit protection devices 10 is the number of the short-circuit protection devices 10 directly connected via the electric wire 30, and does not include the number of the short-circuit protection devices 10 connected via the other short-circuit protection devices 10.

The communication destination addresses of the other short-circuit protection devices 10 are information indicating the communication destination addresses when a signal is transmitted and received via the communication network 20.

For example, when a TCP/IP protocol is used, the communication destination addresses are IP addresses.

The cut-off threshold is a threshold used for determination of controlling the circuit breaker on the basis of a measured current value. The signal waiting time is a time as a reference for determining whether or not a signal is received.

The current value acquisition unit 12 acquires data indicating the current value of the electric wire 30 measured by the current measurement apparatus 103.

The interruption control unit 13 controls the circuit breaker 101 to cut off the current of the electric wire 30 or controls the circuit breaker 101 to be re-closed. Specifically, the interruption control unit 13 determines whether or not the current value of the electric wire 30 exceeds a threshold, and controls the circuit breaker 101 so as to cut off the current of the electric wire 30 when it is determined that the current value exceeds the threshold.

The interruption control unit 13 controls the circuit breaker 101 to be re-closed, according to whether or not the signal reception unit 15 has received a signal from the other short-circuit protection devices 10.

The signal transmission unit 14 transmits a signal to the other short-circuit protection device 10 when the current value of the electric wire 30 exceeds the threshold.

Specifically, when the current value of the electric wire 30 exceeds the threshold, the signal transmission unit 14 transmits a signal to each of the other short-circuit protection devices 10 located downstream along the current at the time of short-circuit.

The command reception unit 15 receives a signal from the other short-circuit protection devices 10. Specifically, the signal reception unit 15 receives a signal from the other short-circuit protection devices 10 within a time period set as the signal waiting time, after the signal transmission unit 14 transmits a signal.

### (Operation of Short-Circuit Protection Device 10)

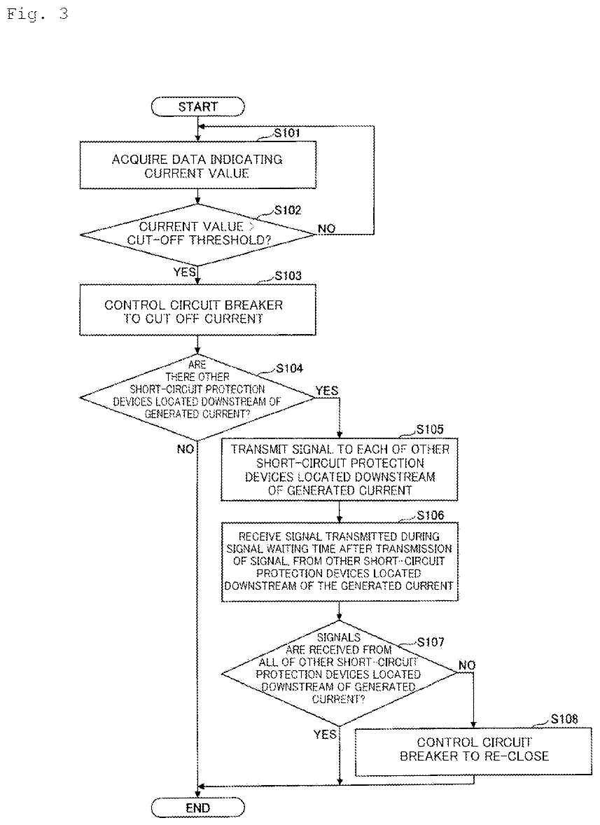

Next, an operation of the short-circuit protection device 10 will be described. FIG. 3 is a flowchart showing an example of a flow of interruption control processing according to the first embodiment.

The short-circuit protection device 10 executes interruption control processing periodically, such as every second. When the short-circuit protection device 10 starts the interruption control processing, the current value acquisition unit 12 acquires data indicating the current value from the current measurement apparatus 103 (step S101).

The interruption control unit 13 determines whether or not the current value exceeds the cut-off threshold (step S102). When the current value can be either positive or negative, the interruption control unit 13 uses the absolute value of the current value for the determination. In so doing, the short-circuit protection device 10 can determine the direction of the current in the processing described later, on the basis of whether the current value is positive or negative.

When the interruption control unit 13 determines that the current value does not exceed the cut-off threshold (step S102: No), the processing returns to the processing of step S101.

When the interruption control unit 13 determines that the current value exceeds the cut-off threshold (step S102: Yes), the interruption control unit 13 controls the circuit breaker 101 to cut off the current (step S103).

Subsequently, the interruption control unit 13 determines whether or not there are other short-circuit protection devices 10 located downstream of the generated current (step S104). When it is determined that other short-circuit protection devices 10 located downstream of the generated current do not exist (step S104: No), the interruption control unit 13 terminates the interruption control processing.

When the interruption control unit 13 determines that other short-circuit protection devices 10 located downstream of the generated current exists (step S104: Yes), the signal transmission unit 14 transmits a signal to each of the other short-circuit protection devices 10 located downstream of the generated current (step S105).

Next, the signal reception unit 15 receives a signal transmitted during the signal waiting time following the transmission of the signals from the other short-circuit protection devices 10 located downstream of the generated current (step S106). Subsequently, the interruption control unit 13 determines whether or not the signals are received from all of the other short-circuit protection devices 10 located downstream of the generated current (step S107).

When it is determined that the signals are received from all of the other short-circuit protection devices 10 located downstream of the generated current (step S107: Yes), the interruption control unit 13 terminates the processing. When it is determined that a signal is not received from any of the other short-circuit protection devices 10 located downstream of the generated current (step S107: No), the interruption control unit 13 controls the circuit breaker 101 to be re-closed (step S108).

Example 1 to Example 4 will now be described, as examples of the short-circuit protection system according to the present embodiment.

### Example 1

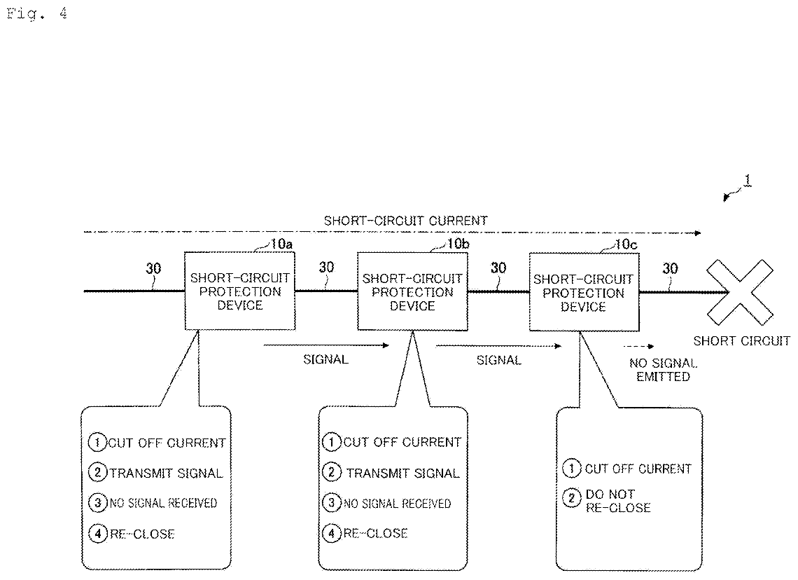

FIG. 4 is a diagram for explaining interruption control according to Example 1.

Example 1 is a case where a short circuit occurs ahead of the short-circuit protection device 10c when the three short-circuit protection devices 10 (10a, 10b and 10c) are connected in series.

In this case, the short-circuit protection device 10a controls the circuit breaker 101 so as to cut off the current when a current value measured by a short-circuit current exceeds a threshold. The short-circuit protection device 10a transmits a signal because there exists the short-circuit protection device 10b located downstream of the measured current.

Since the short-circuit protection device 10b does not transmit a signal to the short-circuit protection device 10a as will be described later, the short-circuit protection device 10a does not receive a signal. Therefore, the short-circuit protection device 10a re-closes the circuit breaker 101.

The short-circuit protection device 10b controls the circuit breaker 101 so as to cut off the current when the current value measured by the short-circuit current exceeds the threshold. The short-circuit protection device 10b transmits a signal because there exists the short-circuit protection device 10c located downstream of the measured current.

Since the short-circuit protection device 10c does not transmit a signal to the short-circuit protection device 10b as will be described later, the short-circuit protection device 10b does not receive a signal. Therefore, the short-circuit protection device 10b re-closes the circuit breaker 101.

The short-circuit protection device 10c controls the circuit breaker 101 so as to cut off the current when the current value measured by the short-circuit current exceeds the threshold. Since there is no short-circuit protection device 10 located downstream of the measured current, the short-circuit protection device 10c does not re-close the circuit breaker 101.

In this manner, the short-circuit protection device 10c that is directly connected to the place where the short circuit has occurred maintains the state of cutting off the current, and the short-circuit protection devices 10a and 10b that are not directly connected to the place where the short circuit has occurred re-close the circuit breaker 101.

### Example 2

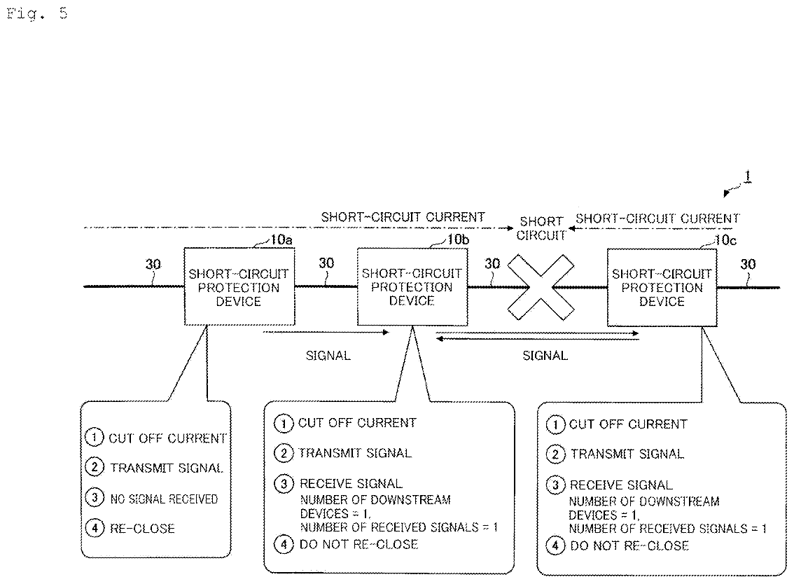

FIG. 5 is a diagram for explaining interruption control according to Example 2.

Example 2 is the case where a short circuit occurs between the short-circuit protection devices 10b and 10c when the three short-circuit protection devices 10 (10a, 10b and 10c) are connected in series.

In this case, the short-circuit protection device 10a controls the circuit breaker 101 so as to cut off the current when a current value measured by a short-circuit current exceeds a threshold. The short-circuit protection device 10a transmits a signal because there exists the short-circuit protection device 10b located downstream of the measured current.

Since the short-circuit protection device 10b does not transmit a signal to the short-circuit protection device 10a as will be described later, the short-circuit protection device 10a does not receive a signal. Therefore, the short-circuit protection device 10a re-closes the circuit breaker 101.

The short-circuit protection device 10b controls the circuit breaker 101 so as to cut off the current when the current value measured by the short-circuit current exceeds the threshold. The short-circuit protection device 10b transmits a signal because there exists the short-circuit protection device 10c located downstream of the measured current.

Since the short-circuit protection device 10c transmits a signal to the short-circuit protection device 10b as will be described later, the short-circuit protection device 10b receives a signal from the short-circuit protection device 10c. Since the number of devices located downstream of the measured current is one and the number of received signals is one, the short-circuit protection device 10b does not re-close the circuit breaker 101.

The short-circuit protection device 10c controls the circuit breaker 101 so as to cut off the current when the current value measured by the short-circuit current exceeds the threshold. The short-circuit protection device 10c transmits a signal because there exists the short-circuit protection device 10b located downstream of the measured current.

Since the short-circuit protection device 10b transmits a signal to the short-circuit protection device 10c, the short-circuit protection device 10c receives a signal from the short-circuit protection device 10c. Since the number of devices located downstream of the measured current is one and the number of received signals is one, the short-circuit protection device 10c does not re-close the circuit breaker 101.

In this manner, the short-circuit protection devices 10b and 10c that are directly connected to the place where the short circuit has occurred maintain the state of cutting off the current, and the short-circuit protection device 10a that is not directly connected to the place where the short circuit has occurred re-closes the circuit breaker 101.

### Example 3

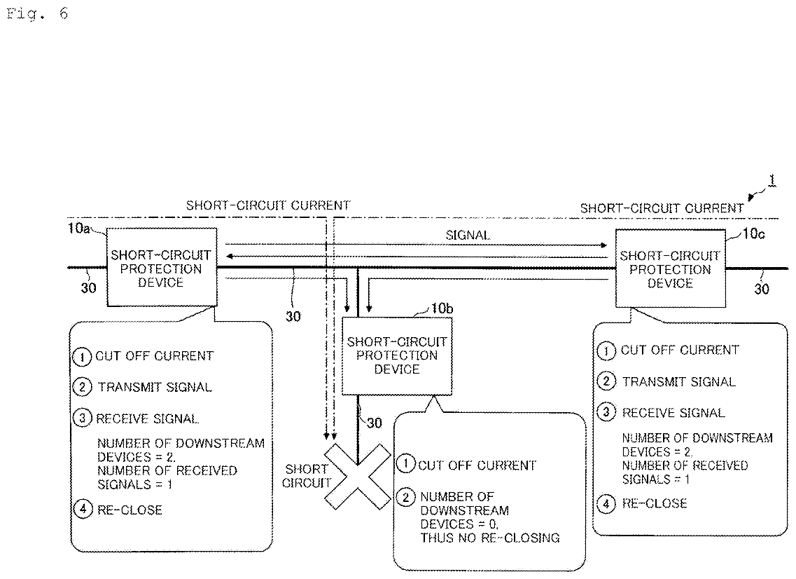

FIG. 6 is a diagram for explaining interruption control according to Example 3.

Example 3 is a case where a short circuit occurs ahead of the short-circuit protection device 10b when the three short-circuit protection devices 10 (10a, 10b and 10c) are connected in a T-shape.

In this case, the short-circuit protection device 10a controls the circuit breaker 101 so as to cut off the current when a current value measured by a short-circuit current exceeds a threshold. The short-circuit protection device 10a transmits a signal because there are the short-circuit protection devices 10b and 10c located downstream of the measured current.

The short-circuit protection device 10b does not transmit a signal to the short-circuit protection device 10a as will be described later. The short-circuit protection device 10c transmits a signal to the short-circuit protection device 10a as will be described later. Therefore, the short-circuit protection device 10a receives a signal only from the short-circuit protection device 10c. Since the number of devices located downstream of the measured current is two and the number of received signals is one, the short-circuit protection device 10a re-closes the circuit breaker 101.

The short-circuit protection device 10b controls the circuit breaker 101 so as to cut off the current when the current value measured by the short-circuit current exceeds the threshold. Since the short-circuit protection device 10b does not have the short-circuit protection device 10 located downstream of the measured current, the short-circuit protection device 10b does not re-close the circuit breaker 101.

The short-circuit protection device 10c controls the circuit breaker 101 so as to cut off the current when the current value measured by the short-circuit current exceeds the threshold. The short-circuit protection device 10c transmits a signal because there are the short-circuit protection devices 10a and 10b located downstream of the measured current.

The short-circuit protection device 10a transmits a signal to the short-circuit protection device 10c. The short-circuit protection device 10b does not transmit a signal to the short-circuit protection device 10c. Therefore, the short-circuit protection device 10c receives a signal only from the short-circuit protection device 10a. Since the number of devices located downstream of the measured current is two and the number of received signals is one, the short-circuit protection device 10c re-closes the circuit breaker 101.

In this manner, the short-circuit protection device 10b that is directly connected to the place where the short circuit has occurred maintains the state of cutting off the current, and the short-circuit protection devices 10a and 10c that are not directly connected to the place where the short circuit has occurred re-close the circuit breaker 101.

### Example 4

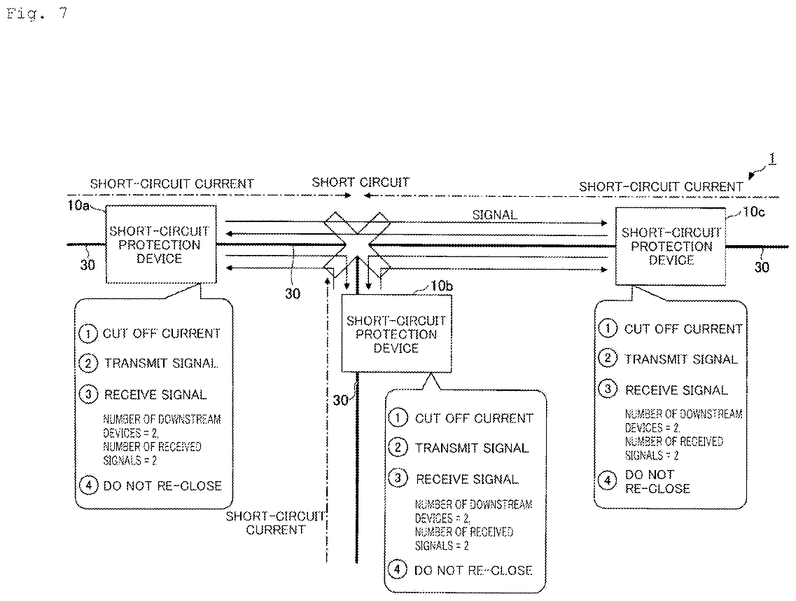

FIG. 7 is a diagram for explaining interruption control according to Example 4.

Example 4 is the case where a short circuit occurs between the short-circuit protection devices 10a, 10b and 10c when the three short-circuit protection devices 10 (10a, 10b and 10c) are connected in a T-shape.

In this case, the short-circuit protection device 10a controls the circuit breaker 101 so as to cut off the current when a current value measured by a short-circuit current exceeds a threshold. The short-circuit protection device 10a transmits a signal because there are the short-circuit protection devices 10b and 10c located downstream of the measured current.

The short-circuit protection device 10b transmits a signal to the short-circuit protection device 10a as will be described later. The short-circuit protection device 10c transmits a signal to the short-circuit protection device 10a as will be described later. Therefore, the short-circuit protection device 10a receives signals from the short-circuit protection devices 10b and 10c. Since the number of devices located downstream of the measured current is two and the number of received signals is two, the short-circuit protection device 10a does not re-close the circuit breaker 101.

The short-circuit protection device 10b controls the circuit breaker 101 so as to cut off the current when the current value measured by the short-circuit current exceeds the threshold. The short-circuit protection device 10b transmits a signal because there are the short-circuit protection devices 10a and 10c located downstream of the measured current.

The short-circuit protection device 10a transmits a signal to the short-circuit protection device 10b. The short-circuit protection device 10c transmits a signal to the short-circuit protection device 10b as will be described later. Therefore, the short-circuit protection device 10b receives signals from the short-circuit protection devices 10a and 10c. Since the number of devices located downstream of the measured current is two and the number of received signals is two, the short-circuit protection device 10b does not re-close the circuit breaker 101.

The short-circuit protection device 10c controls the circuit breaker 101 so as to cut off the current when the current value measured by the short-circuit current exceeds the threshold. The short-circuit protection device 10c transmits a signal because there are the short-circuit protection devices 10a and 10b located downstream of the measured current.

The short-circuit protection device 10a transmits a signal to the short-circuit protection device 10c. The short-circuit protection device 10b transmits a signal to the short-circuit protection device 10c. Therefore, the short-circuit protection device 10c receives signals from the short-circuit protection devices 10a and 10b. Since the number of devices located downstream of the measured current is two and the number of received signals is two, the short-circuit protection device 10c,

Thus, the short-circuit protection devices 10a, 10b, and 10c that are directly connected to the place where the short circuit has occurred maintain a state where the current is cut off.

According to the short-circuit protection system 1 according to the present embodiment, the short-circuit protection device 10 controls each circuit breaker 101 by independent determination processing, so that only the circuit breaker 101 directly connected to the portion where a short circuit has occurred is controlled to cut off the current as a whole.

Thus, since it is not necessary for the server device or the like to collect information from the plurality of short-circuit protection devices 10 or instruct each short-circuit protection device 10, the time for cutting off the current can be shortened. Since complicated control processing by the server device or the like is not required, the introduction of the system or the change of the configuration or the like can be easily performed.

Each short-circuit protection device 10 cooperates with the other short-circuit protection devices 10, thereby eliminating the need for increasing a margin such as the threshold and the operation time limit of the upstream circuit breaker, for example, so that erroneous operation is reduced and more accurate operation is enabled.

The short-circuit protection device 10 performs control to cut off the current according to the measured value of the current value, and then performs control to re-close the circuit breaker 101 according to the signal reception state. Accordingly, both quick current interruption and proper re-closing can be realized.

### Second Embodiment

A second embodiment will be described below with reference to the drawings. The second embodiment is different from the first embodiment in that the circuit breaker is interrupted in accordance with the signal reception status. Therefore, in the following description of the second embodiment, the differences from the first embodiment are mainly described, and the same reference numerals as those used in the description of the first embodiment are given to the components having the same functional configurations as those of the first embodiment, omitting the description thereof accordingly.

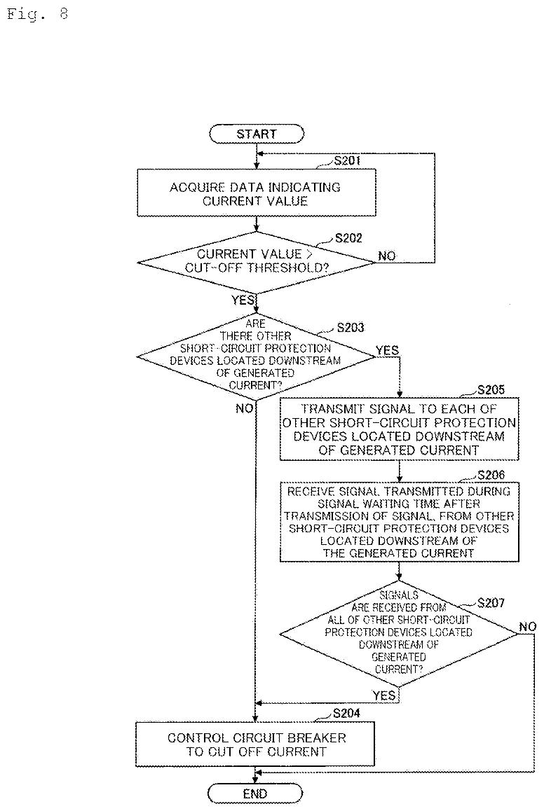

FIG. 8 is a flowchart showing an example of a flow of interruption control processing according to the second embodiment.

Processing from steps S201 to S202 of the interruption control processing according to the present embodiment is the same as the processing from steps S101 to S102 of the interruption control processing according to the first embodiment.

In step S202, when it is determined that the current value exceeds a cut-off threshold (step S202: Yes), the interruption control unit 13 determines whether or not other short-circuit protection devices 10 located downstream of the generated current exist (step S203).

When it is determined that other short-circuit protection devices 10 located downstream of the generated current do not exist (step S203: No), the interruption control unit 13 controls the circuit breaker 101 to cut off the current (step S204).

When the interruption control unit 13 determines that other short-circuit protection devices 10 located downstream of the generated current exist (step S203: Yes), the signal transmission unit 14 transmits a signal to each of the other short-circuit protection devices 10 located downstream of the generated current (step S205).

Next, the signal reception unit 15 receives a signal transmitted during the signal waiting time following the transmission of the signals from the other short-circuit protection devices 10 located downstream of the generated current (step S206). Subsequently, the interruption control unit 13 determines whether or not the signals are received from all of the other short-circuit protection devices 10 located downstream of the generated current (step S207).

When it is determined that signals are received from all of the other short-circuit protection devices 10 located downstream of the generated current (step S207: Yes), the interruption control unit 13 controls the circuit breaker 101 to cut off the current (step S204).

When it is determined that the signal is not received from any pf the other short-circuit protection devices 10 located downstream of the generated current (step S207: No), the interruption control unit 13 terminates the processing.

According to the short-circuit protection system 1 according to the present embodiment, the circuit breaker 101 directly connected to the short-circuit portion can be controlled to interrupt the current, and the circuit breaker 101 not directly connected cannot be controlled.

Further, the short-circuit protection device 10 according to the present embodiment can achieve appropriate interruption of only the circuit breaker 101, to control the circuit breaker 101 in accordance with the signal reception status.

### Conclusion of Embodiments

The present specification describes the short-circuit protection system, the short-circuit protection device, the short-circuit protection method, and the program that are described in at least the following clauses.

### (Clause 1)

A short-circuit protection system comprising a plurality of short-circuit protection devices,
wherein each of the plurality of short-circuit protection devices includes:
a current value acquisition unit that acquires data indicating a current value of an electric wire;
a signal transmission unit that transmits a signal to another short-circuit protection device when the current value exceeds a threshold;
a signal reception unit that receives a signal from another short-circuit protection device; and
an interruption control unit that controls a circuit breaker to cut off a current of the electric wire or controls the circuit breaker to re-close, based on whether or not the signal from said another short-circuit protection device is received.

### (Clause 2)

The short-circuit protection system according to clause 1, wherein the interruption control unit controls the circuit breaker to cut off the current of the electric wire when the current value exceeds the threshold, and controls the controlled circuit breaker to re-close when the signal reception unit does not receive a signal from any of other short-circuit protection devices located downstream of the current before a reference time elapses after the transmission of the signal.

### (Clause 3)

The short-circuit protection system according to clause 1, wherein the interruption control unit determines whether or not there exist other short-circuit protection devices located downstream of the current when the current value exceeds the threshold, or controls the circuit breaker to cut off the current of the electric wire when the signal reception unit does not receive a signal from all of the other short-circuit protection devices located downstream of the current before a reference time elapses after the transmission of the signal.

### (Clause 4)

A short-circuit protection device, comprising:
a current value acquisition unit that acquires data indicating a current value of an electric wire;
a signal transmission unit that transmits a signal to another short-circuit protection device when the current value exceeds a threshold;
a signal reception unit that receives a signal from another short-circuit protection device; and
an interruption control unit that controls a circuit breaker to cut off a current of the electric wire or controls the circuit breaker to re-close, based on whether or not the signal from said another short-circuit protection device is received.

### (Clause 5)

A short-circuit protection method, causing each of a plurality of short-circuit protection devices to execute the steps of: acquiring data indicating a current value of an electric wire; transmitting a signal to another short-circuit protection device when the current value exceeds a threshold;
receiving a signal from another short-circuit protection device; and
controlling a circuit breaker to cut off a current of the electric wire or controlling the circuit breaker to re-close, based on whether or not the signal from said another short-circuit protection device is received.

### (Clause 6)

A program for causing a computer to function as each unit of the short-circuit protection device according to clause 4.

Although the embodiments have been described above, the present invention is not limited to such specific embodiments, and various modifications and changes can be made within the scope of the gist of the present invention described in the claims.

### REFERENCE SIGNS LIST

1 Short-circuit protection system
10 Short-circuit protection device
11 Setting information storage unit
12 Current value acquisition unit
13 Interruption control unit
14 Signal transmission unit
15 Signal reception unit
20 Communication network
21 Communication line
30 Electric wire
101 Circuit breaker
102 Control device
103 Current measurement apparatus
104 Storage device
105 Communication apparatus

1. A short-circuit protection system comprising a plurality of short-circuit protection devices,
wherein each of the plurality of short-circuit protection devices includes:
a memory; and
a processor configured to:
acquire data indicating a current value of an electric wire;
transmit a first signal to one or more other short-circuit protection devices, in response to the current value exceeding a threshold;
receive a second signal from each of the one or more other short-circuit protection devices; and
control a circuit breaker to cut off a current of the electric wire, or controls the circuit breaker to re-close, based on whether or not the second signal from said each of the one or more other short-circuit protection devices is received.

2. The short-circuit protection system according to claim 1, wherein the processor controls the circuit breaker to cut off the current of the electric wire in response to the current value exceeding the threshold, and controls the controlled circuit breaker to re-close, upon determining that the second signal from any of other short-circuit protection devices that are located downstream of the current is not received before a reference time elapses after transmission of the first signal.

3. The short-circuit protection system according to claim 1, wherein in response to the current value exceeding the threshold, the processor controls the circuit breaker to cut off the current of the electric wire, upon determining that no short-circuit protection devices are located downstream of the current, or upon determining that the second signal from any of the other short-circuit protection devices that are located downstream of the current is not received before a reference time elapses after transmission of the first signal.

4. A short-circuit protection device, comprising:
a memory; and
a processor configured to:
acquire data indicating a current value of an electric wire;
transmit a first signal to another one or more other short-circuit protection devices, in response to the current value exceeding a threshold;
receive a second signal from each of the one or more other short-circuit protection devices; and
control a circuit breaker to cut off a current of the electric wire, or controls the circuit breaker to re-close, based on whether or not the second signal from said each of the one or more other short-circuit protection devices is received.

5. A short-circuit protection method, executed by each of a plurality of short-circuit protection devices included in a short-circuit protection system, the short-circuit protection method comprising:
acquiring data indicating a current value of an electric wire;
transmitting a first signal to one or more other short-circuit protection devices, in response to the current value exceeding a threshold;
receiving a second signal from each of the one or more other short-circuit protection devices; and
controlling a circuit breaker to cut off a current of the electric wire, or controlling the circuit breaker to re-close, based on whether or not the second signal from said each of the one or more other short-circuit protection devices is received.

6. A non-transitory computer-readable recording medium having computer-readable instructions stored thereon, which, when executed, cause a computer to perform the short-circuit protection method according to claim 5.
